(19) United States
(12) Patent Application Publication
(10) Pub. No.: US 2010/0042399 A1
(43) Pub. Date: Feb. 18, 2010

(54) Transviewfinder

(76) Inventor: David Park, (US)

Correspondence Address: David Park, 1722 Spruce St Apt B2, Philadelphia, PA, 19103, US

(21) Appl. No.: 12/190,578

(22) Filed: Aug. 12, 2008

(51) Int. Cl. G06F 17/28

(52) U.S. Cl. 704/8

(57) ABSTRACT

The method for a digital imaging device to recognize text on the captured image or video and translate the text to operator's desired language as an overlay to the original image in real-time or replay mode. The image or video is processed in real-time cross referencing translation data and text recognition algorithms allowing the operator to view translated text from the device's monitor and/or electronic viewfinder. Images and video that are stored in media can be replayed with or without the translated text since the translation data is saved as a discrete layer to the image, thus the operator can choose alternate translations. The device screen or viewfinder can have operator defined zones within the field of view of the imaging device where text recognizable by the imaging device will execute translation methods applicable to the zone.

### CROSS-REFERENCES

The existing technologies that Transviewfinder can leverage are:
1. Software—OCR—Optical Character Recognition
   a. Optical character recognition, usually abbreviated to OCR, is the mechanical or electronic translation of images of handwritten, typewritten or printed text (usually captured by a scanner) into machine-editable text. (Wikipedia, 2008)
2. Software—Translation database—Multiple Languages
3. Hardware—CCD or CMOS sensors
   a. CCD and CMOS sensors are typically used for digital imaging in cameras

The device/process leverages existing digital imaging technologies, but the combination of post-processing techniques are unique. The Transviewfinder device uses internal circuitry and processors to execute OCR algorithms to decipher the digitally captured text within the images and translate the text to a desired language with use of a reference database of languages. Currently, digital imaging devices exist in many forms from cameras to flatbed scanners for documents. The Transviewfinder is a device that is to be used like a camera. Cameras fall into the following categories: digital camera, digital single lens reflex, and digital camcorders or digital video cameras, camera phones, and other devices typically used for surveillance, vacation, travel, journalism, and education.

### BACKGROUND OF THE SUMMARY OF INVENTION

Having travelled abroad and being a photography enthusiast, I have brought home numerous photos of distant nations and cultures. These photos contain foreign text and I often wonder what the words mean. Since the image is taken digitally, the data can pass through a process that can:
1. convert ‘scribe’ into text
2. lookup text in an internal database
3. output translation to the image—or video (collection of images)
4. or output to electronic viewfinder or live preview screen.

Future versions will have processing speed that can render and translate the words in near real-time. For instance, using a video camera could have several modes. The words can be translated and recorded as the image reaches the live preview—or a button can be depressed to translate the words and transmit to the preview screen.

The digital imaging device in the family of cameras or other device where the image is previewed live and/or digitally to the operator when the image(s) are captured; the device consists a digital sensor and processing software to detect recognizable text for language translation output of the operator's choice; translation can be viewed on a preview screen and/or saved onto media.

1. A method for digital imaging devices to recognize captured text comprising:
character recognition process to extrapolate captured text;
and output user desired language translation text to file storage or device screen or viewfinder

2. A method for digital imaging devices to recognize captured text as in claim 1, wherein said output file is a combined image or collection of images; of originally captured image and translated text as overlay or discrete layered image.

3. A method for digital imaging devices to recognize captured text as in claim 1, wherein said output to screen is retrieved from stored file as claimed in claim 2.

4. A method for digital imaging devices to recognize captured text as in claim 1, wherein said output and translation to screen is displayed in real-time

5. A method for digital imaging devices to recognize captured text as in claim 4, wherein said real-time data can be stored to media for retrieval as claimed in claim 3; user selected language can be changed for review as claimed in claim 1

6. A method for digital imaging devices to recognize captured text as in claim 1, wherein character recognition process can be modified via software and hardware, and language translation database modified, and re-applied to stored data, and image or video retrieved as claimed in claim 5.

7. A method for the operator to select specific text or zone on the device screen for text translation
